(19) United States
(12) Patent Application Publication
(10) Pub. No.: US 2026/0311483 A1
(43) Pub. Date: Oct. 8, 2026

(54) METHOD FOR GENERATING THE VECTOR OF SPATIAL ATTRIBUTES FOR CHARACTERIZING OIL SPILLS ON THE SEA SURFACE

(71) Applicants: PETRÓLEO BRASILEIRO S.A. - PETROBRAS, Rio de Janeiro (BR); FACULDADES CATÓLICAS, Rio de Janeiro (BR)

(72) Inventors: GIL MARCIO AVELINO SILVA, Rio de Janeiro (BR); CARLOS HENRIQUE BEISL, Rio de Janeiro (BR); FRANCISCO FÁBIO DE ARAÚJO PONTE, Rio de Janeiro (BR); FERNANDO PELLON DE MIRANDA, Rio de Janeiro (BR); TIAGO DE SOUZA MOTA, Rio de Janeiro (BR); RAFAEL BARBOSA NASSER, Rio de Janeiro (BR); SARAH BARRÓN TORRES, Rio de Janeiro (BR); ITALO DE OLIVEIRA MATIAS, Rio de Janeiro (BR); GABRIELLE DE SOUZA BRUM, Rio de Janeiro (BR); GUSTAVO ROBICHEZ DE CARVALHO, Rio de Janeiro (BR)

(21) Appl. No.: 19/578,116

(22) Filed: Mar. 25, 2026

(30) Foreign Application Priority Data
Apr. 4, 2025 (BR) 10 2025 006698 0

(51) Int. Cl. G06V 20/13; G01S 13/90; G06V 10/75

(52) U.S. Cl. CPC G06V 20/13; G06V 10/751; G01S 13/90

(57) ABSTRACT

The present invention relates to a method aimed at generating the vector of spatial attributes to improve the process of characterizing oil on the sea surface using Synthetic Aperture Radar (SAR) imagery, seeking to increase the accuracy of classifying the origin of the oil spill (natural or anthropic). To implement the method, a set of spatial attributes was generated by combining semivariograms and lagged states spaces diagrams in an unprecedented way, for use in conjunction with the already traditional geometric and radiometric attributes. The method described herein aims at contributing significantly to the monitoring of the oil seepage phenomenon, which is of great scientific and environmental importance. Such a result can provide subsidies to aid in understanding the dynamics of active oil systems, reducing the exploratory risk in the decision-making process.

### CROSS REFERENCE TO RELATED APPLICATIONS

The present application claims priority to BR Pat. App. No. 1020250066980 filed on Apr. 4, 2025, which is hereby incorporated by reference in its entirety.

### FIELD OF THE INVENTION

The present invention pertains to the technical field of oil engineering and consists of a method for generating the vector of spatial attributes to characterize oil on the sea surface from Synthetic Aperture Radar (SAR) images, using lagged states spaces diagrams and semivariograms, which leads to the improvement of a model for automatic classification of oil spills originating from oil exploration, production and transportation areas.

### BACKGROUNDS OF THE INVENTION

As a consequence of oil exploration, production and transportation activities, oil leaks may occur from platforms, pipelines or oil may be disposed of from vessels, herein referred to as oil spills. Since non-biodegradable oil is less dense than seawater, the oil remains on the ocean surface forming a thin film. However, not all oil observed on the sea surface is of anthropogenic origin. Sometimes, the migration occurs naturally, where the oil flows through the geological section from the source rock to the ocean floor and, in turn, reaches the sea surface. This phenomenon is known as seepage. The geological features that allow the migration of oil through the sedimentary column are faults or outcropping unconformities, as well as carrier layers.

The observation of oil spills associated with seepages is extremely useful for the oil industry, as it allows the identification of active oil systems. For this purpose, an effective tool for characterizing oil spills on the sea surface is necessary.

Synthetic Aperture Radars (SARs) are the main orbital sensors used for this purpose. Such systems offer rapid data delivery and the ability to cover extensive areas, acquiring images regardless of the atmospheric conditions during day and night.

These systems emit electromagnetic waves that interact with the ocean surface and, upon returning to the sensor, allow information to be inferred about the texture of the imaged area. The presence of an oil film in oceanic areas reduces the surface roughness of the sea, causing the return signal to be locally attenuated. Thus, the oil spill is identified as a dark target with a smooth texture in the SAR images, standing out from the surrounding marine areas devoid of oil.

The problem associated with identifying the oil spills through SAR is due to ambiguities generated in the interpretation of their origin, as being of natural or anthropic origin. Such an issue has been addressed using geometric and radiometric attributes of the oil spill.

### DESCRIPTION OF THE STATE OF THE ART

Currently, the most common procedures applied in oil spill analysis include: a) reading, visualization, and manipulation of the radar images; b) manual delimitation of transect boundary points within oil features and the surrounding marine area; c) generation of a preview image of the interval encompassed by the transect points; and d) generation of analysis graphs, including (i) the distribution of values of the transect points, (ii) spherical semivariograms corresponding to each of them, and (iii) lagged states spaces diagrams.

Scientific documents describing methodologies for detecting spilled residues at sea are also found in the state of the art.

Document ES2392411B2 describes a method and system for detecting hydrocarbon spills on the ocean surface from the study of radiation reflected by the same. The system described in this document uses synthetic aperture radar data analysis to provide surface information, even in adverse weather conditions and low light conditions, such as at night. Through the steps of SAR image calibration and georeferencing, pre-processing of the obtained image, segmentation of the pre-processed image, characterization of the image segments, and classification of the already characterized segments, the described detection system and method are capable of generating a georeferenced list of areas where hydrocarbon spills are present.

Document US20240062512A1 describes a method for identifying, quantifying, and remediating an oil spill on water. This method combines in situ data, machine learning models, and remote sensing technology, being able to identify the type of oil spilled, as well as the appearance of the spill, from satellite imagery, making it possible to estimate the volume and location of the oil spill, predict the movement of the oil spill, and remediate the same.

Document CN109490886A describes an approach to accurately identify oil spill areas on the sea surface using synthetic aperture radar remote sensing imagery. One of the challenges addressed by this technique is the difficulty in effectively distinguishing the presence of mineral oil and biological oil films. The method proposes a pre-processing, which involves geocoding the SAR image and extracting sample areas to identify mineral oil, non-mineral oil, and the probability of biological films, performing the polarimetric filtering on the SAR images, extracting the polarimetric features from the polarimetric filtering, using a SAE to distinguish areas covered by mineral and non-mineral oil, and using a Gaussian convolution kernel to process the backscattered signals from the VV channel and perform the spatial density segmentation, in addition to applying morphological processing to the classification results.

Document CN111861918B describes a method for detecting oil spills at sea based on SAR images, automatically performing the efficient and rapid detection of oil spill areas on the sea surface, in order to automatically perform the efficient and rapid detection of oil spill areas on the sea surface based on SAR images. The method involves detecting oil spills at sea based on SAR images by using the following steps: first, the SAR image to be analyzed is copied into two versions, each undergoing different filtering processes to eliminate some of the noise. Next, the images are enhanced for contrast and segmented using a sliding window, applying the principle of maximum entropy to determine the ideal segmentation threshold, which allows for the identification of the oil spill area and the background. The segmented images are then combined to form a final mirrored image, which is used for recognition.

The paper—“Detecção e caracterização de óleo na superfície do mar do Golfo do México utilizando uma imagem SAR da constelação CAPELLA SPACE: abordagem corn diagramas de espaços de estados defasados e semivariogramas” (“Detection and characterization of oil on the sea surface of the Gulf of Mexico using a SAR image from the CAPELLA SPACE constellation: an approach with lagged states spaces diagrams and semivariograms”)—published in 2023 describes a methodology that uses SAR image data from the CAPELLA SPACE constellation to detect and characterize oil spills on the sea surface, focusing on the Cantarell oil seepage region in the Gulf of Mexico. The approach involves the use of transect lines, which are lines drawn on the SAR image, representing the gray level of each pixel they traverse. These gray values are proportional to the amplitude of the radar backscattered signal, providing a one-dimensional representation of the spatial variation of the studied targets, such as the sea and oil. The methodology also includes the application of spherical semivariograms to study spatial continuity along the transects. The spherical semivariogram model is used to extract geostatistical parameters, such as range, nugget effect, and sill, allowing the analysis of the spatial variability of the targets. As described in the document, for both sea and oil, the semivariograms showed a spherical behavior, without the presence of the nugget effect, which suggests the absence of randomness or small-scale variability. In addition, the application of a median filter with a 5×5 window was used to reduce speckle noise, increasing the spatial structure of the data.

Another central technique used in the methodology is the construction of lagged states spaces diagrams. These diagrams were created from the variation of DN values along the transects and are used to characterize the transition between the structured domain (with spatial correlation) and the random domain of the data. The diagrams showed distinct behaviors for the sea and oil areas, demonstrating their potential to differentiate these features. The diagnostic behavior of these trajectories in the diagrams is indicative of the spatial organization of the targets.

Finally, the methodology integrates the extracted spatial attributes, such as semivariogram parameters and lagged states diagrams information, to robustly characterize oil spills and the sea surface. The combination of these geostatistical analysis techniques and SAR image processing allows for a detailed and accurate assessment of the oil features on the ocean surface, making the methodology efficient for environmental studies and oil spill monitoring.

### BRIEF DESCRIPTION OF THE INVENTION

The present invention relates to a method for generating the vector of spatial attributes for characterizing oil spills on the sea surface, which consists of selecting spatial attributes by means of the combination of semivariograms and lagged states spaces diagrams.

The method aims at contributing significantly to improving the classification of oil spills on the sea surface as being of natural or anthropic origin based on the generated vector of spatial attributes. In this step, the vector of spatial attributes of the surrounding sea is used for comparison and to aid in distinguishing the origin of the oil spills.

The validation of the techniques and methods presented was carried out through the implementation of a functional prototype, in the form of a computational tool, respecting the format and integrity of the SAR images and aiming at the visualization and statistical analysis of the data from the transects determined by the system user. This computational tool was planned and implemented to enable the execution of a routine of sequential and consecutive operations, for the definition of the vector of spatial attributes for the investigated transects.

In this context, the generation of the vector of spatial attributes combining semivariograms and lagged states spaces diagrams constitutes an unprecedented contribution, adding value to the solution of the aforementioned ambiguity.

In view of this, there is no teaching observed in the state of the art on a well-defined methodology for generating the vector of spatial attributes for characterizing oil spills on the sea surface using SAR images.

In this way, the present invention is achieved by combining parameters associated with the spatial distribution of the targets with the purpose of generating a vector of spatial attributes to be used as additional information to distinguish the origin of oil spills as natural or anthropic.

The application of the said invention presents numerous advantages, since it can provide subsidies to contribute to the characterization of active oil systems, reducing the exploratory risk for the generation and migration in the decision-making process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will be described in more detail below, with reference to the figures attached to the present application.

FIG. 1 illustrates a flowchart that includes all the steps used in the development of the method for generating a vector of spatial attributes of the present invention.

FIG. 2 illustrates (A) Capella Space image illustrating the features corresponding to the oil seepage and spill and (B) Textural classification by semivariograms (USTC) illustrating the polygons of the seepage (left side) and the oil spill (right side) detected in the digital processing of the SAR image.

FIG. 3 illustrates transects and targets indicated in the SAR image.

FIG. 4 illustrates semivariograms with detail for the separation distances in pixels (h) from 1 to 20 of the sea transect: (A) in the original image and (B) in the image with a 5×5 median filter, with the average DN(x) value in the transect line being 97, with a variance of 3273 for the original image, and 90 with a variance of 1009 for the filtered image.

FIG. 5 illustrates semivariograms with details for the separation distances in pixels (h) from 1 to 20 of the oil seepage transect: (A) in the original image and (B) in the image with a 5×5 median filter, with the average DN(x) value in the transect line being 70, with a variance of 2113 for the original image, and 55 with a variance of 597 for the filtered image.

FIG. 6 illustrates semivariograms with details for the separation distances in pixels (h) from 1 to 20 of the oil spill transect: (A) in the original image; and (B) in the image with a 5×5 median filter, with the average DN(x) value in the transect line being 68, with a variance of 2028 for the original image, and 51 with a variance of 449 for the filtered image.

FIG. 7 illustrates lagged states spaces diagrams (<DN(x), DN(x+k)>) with k=1 to k=a+1 of the sea transect line in the original image, where a=4 in this diagram, as shown in FIG. 4A.

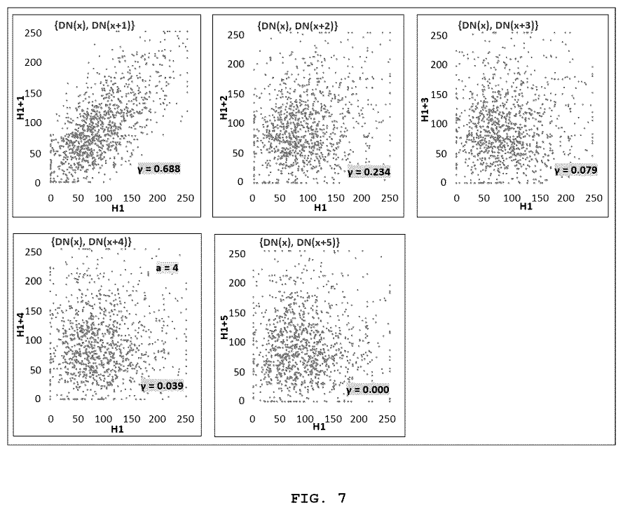

FIG. 8 illustrates lagged states spaces diagrams (<DN(x), DN(x+k)>) with k=1 to k=a+1 of the sea transect line in the filtered image, where a=8 in this diagram, as shown in FIG. 4B.

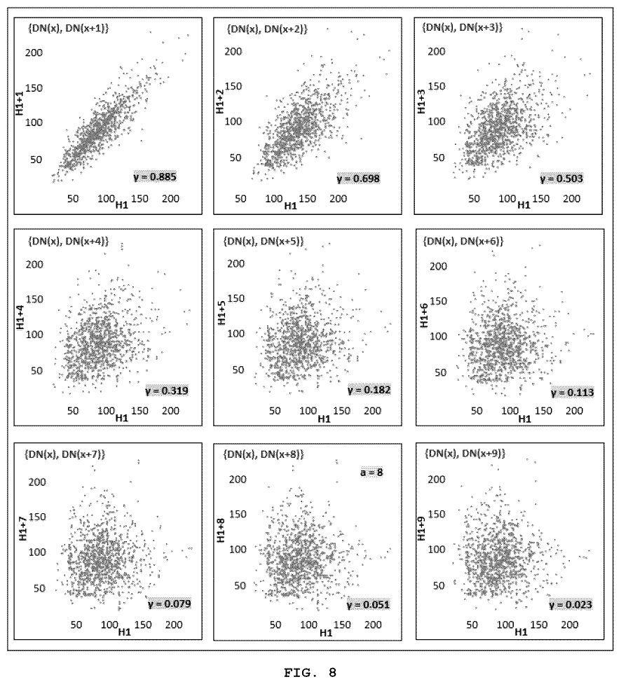

FIG. 9 illustrates lagged states spaces diagrams (<DN(x), DN(x+k)>) with k=1 to k=a+1 of the oil seepage transect line in the original image, where a=4 in this diagram, as shown in FIG. 5A.

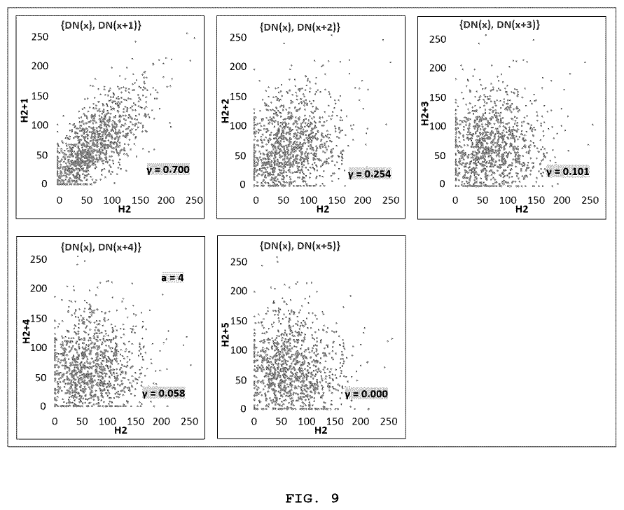

FIG. 10 illustrates lagged states spaces diagrams (<DN(x), DN(x+k)>) with k=1 to k=a+1 of the oil seepage transect line in the filtered image, where a=7 in this diagram, as shown in FIG. 5B.

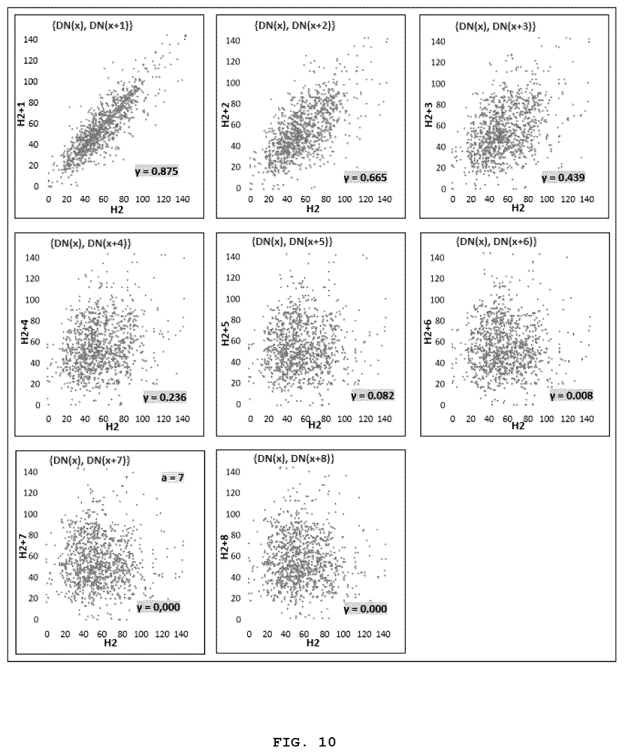

FIG. 11 illustrates lagged states spaces diagrams (<DN(x), DN(x+k)>) with k=1 to k=a+1 of the oil spill transect line in the original image, where a=3 in this diagram, as shown in FIG. 6A.

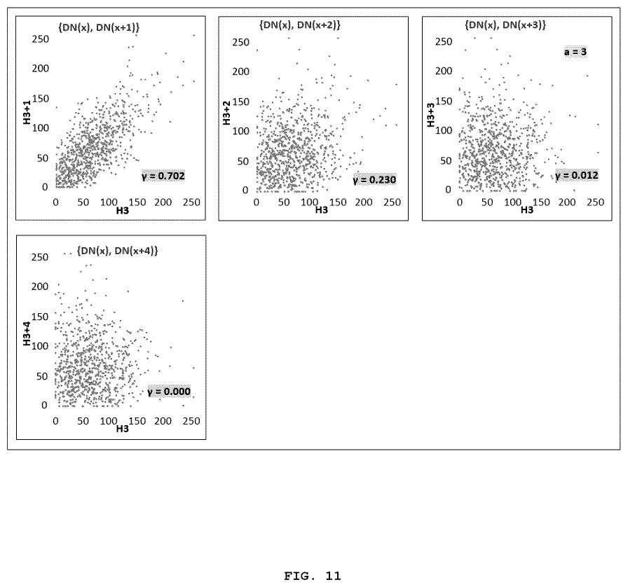

FIG. 12 illustrates lagged states spaces diagrams (<DN(x), DN(x+k)>) with k=1 to k=a+1 of the oil spill transect line in the filtered image, where a=6 in this diagram, as shown in FIG. 6B.

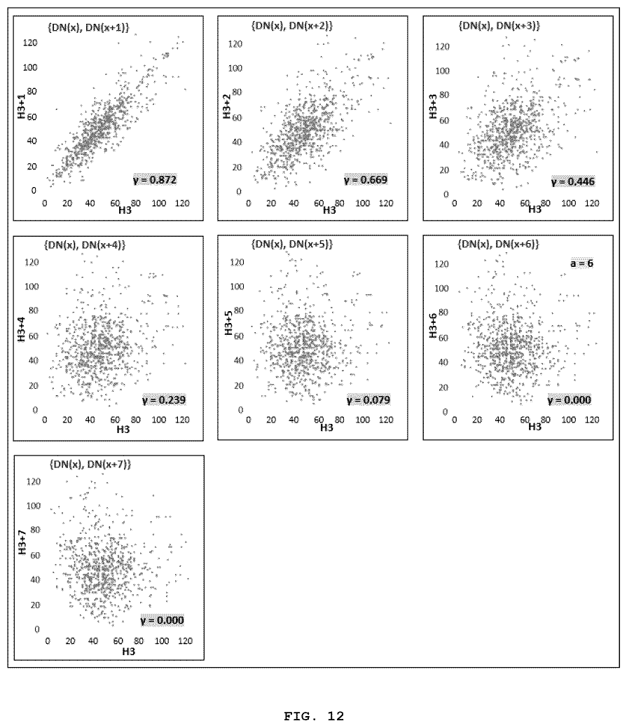

### DETAILED DESCRIPTION OF THE INVENTION

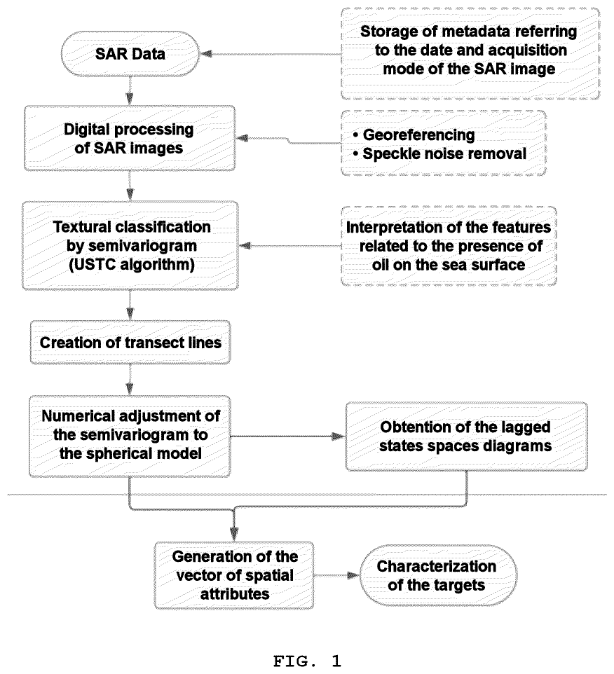

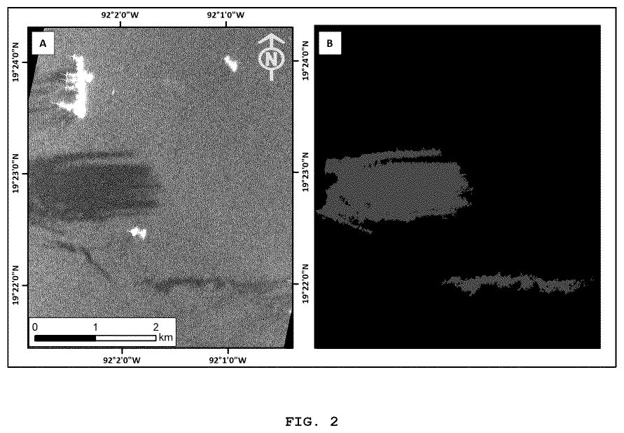

For the development of the methodology as shown in the flowchart in FIG. 1, a CAPELLA SPACE image acquired on Apr. 14, 2022, at 20:41 GMT (Greenwich Mean Time), in the X-band, in Stripmap imaging mode, in descending orbit, with left observation direction, VV polarization and incidence angle of 31.5° (image A of FIG. 2) was used as an example.

Subsequently, the SAR image was pre-processed, which is necessary due to the constructive and destructive interferences of the radar signal as it is backscattered by the ocean surface. Such interferences degrade the quality of the data, since they cause large fluctuations in the DN (Digital Number or Gray Level) values between very close pixels. This effect is called speckle noise and is characterized by the grainy appearance (“salt and pepper” effect) imposed on the SAR images.

In order to minimize the impacts of the speckle noise, the use of multi-look processing or the application of filters is recommended. The filters should maintain the average value of the radar return, preserve the edges present in the image and the texture information.

In the present method, the median filter with a 5×5 pixel window was used. This filter replaces the central element of a region with the gray level value that corresponds to the median of its interior neighbors within a moving window of n×n pixels. This filtering causes a smoothing of the signal, by discarding points that are too high or too low in relation to the signal median value, without, however, blurring the edges of the regions.

It is important to highlight that, depending on the SAR image provider, the type of filter and the size of the window may eventually be different from those mentioned above.

In the interpretation of the oil features, the variations in tone and texture of the radar images are characterized, respectively, by the gray level values contained in the pixels and by the interrelation and spatial distribution of these gray levels. The texture of the digital images is mainly based on three factors: local contrast, scale, and preferred orientation.

In this way, in the textural analysis of an image, not only the individual value of each pixel should be considered, but also the spatial arrangement between that pixel and its neighborhood. This relation can be calculated by using geostatistical methods, such as the semivariogram function.

The paper by MIRANDA et al. (ANALYSIS OF RADARSAT-1 DATA FOR OFFSHORE MONITORING ACTIVITIES IN THE CANTARELL COMPLEX, GULF OF MEXICO, USING THE UNSUPERVISED SEMIVARIOGRAM TEXTURAL CLASSIFIER (USTC). Canadian Journal of Remote Sensing, 2004, 30(3), 424-436) addresses to the use of the unsupervised semivariogram textural classification algorithm (Unsupervised Semivariogram Textural Classifier—USTC), which consists of a deterministic classifier that allows the combination of the textural and radiometric information contained in the SAR images, with the textural information contained in the form and value of the semivariogram function. The radiometric information is expressed by the intrinsic gray level value of the pixels that make up the image after the speckle noise removal.

In this way, the USTC classifier was used to discriminate texturally smooth (low roughness) low-return areas from intermediate-return, intermediate-textured (relatively higher roughness) areas in the SAR images. The texturally smooth areas are highlighted and isolated for the identification of oil seepages and spills (image B of FIG. 2).

The study of oil features on the sea surface was carried out by creating transect lines or transects, that is, lines that cross the SAR image and provide the gray level value of each pixel they traverse. Such values are proportional to the amplitude of the signal returning to the radar antenna and result from the interaction of the electromagnetic energy pulse transmitted by the sensor with the oil features present on the ocean surface.

A first contribution to defining the spatial distribution of the targets by using transects was provided in the paper by SILVA et al. (DETECÇCÃO E CARACTERIZAÇÃO DE ALVOS NA IMAGEM RADARSAT-1 DA SUPERFÍCIE DO MAR NO GOLFO DO MÉXICO UTILIZANDO DIAGRAMAS DE ESPAÇOS DE ESTADOS DEFASADOS (DETECTION AND CHARACTERIZATION OF TARGETS IN THE RADARSAT-1 IMAGE OF THE SEA SURFACE IN THE GULF OF MEXICO USING LAGGED STATES SPACES DIAGRAMS). In: XIX Brazilian Symposium on Remote Sensing, 2019, Santos. Electronic proceedings . . . São José dos Campos, INPE, 2019). Each transect represents a collection of “signals” that vary as a function of space in the time interval in which the SAR image was acquired. These signals describe the behavior of the systems constituted by the sea surface and by oil spills identified on it. This representation explicitly shows the signals in the form DN(x), constituting a one-dimensional spatial series.

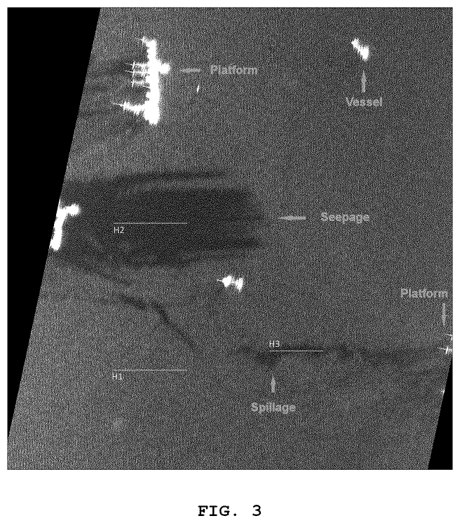

Thus, three main sub-areas (classes) were selected in the SAR image, one being a region of the sea without oil, another in an oil seepage feature and the last in an oil spill. Next, a horizontal transect line was visually selected and manually drawn in each of these sub-areas to be analyzed as shown in FIG. 3. In this procedure, it is essential to ensure that each transect line is entirely contained within the sub-area corresponding to the class of interest, i.e., without contamination by pixels from other classes.

For the study of the spatial continuity of the transect line through the numerical adjustment of the semivariogram to the spherical model, an additional contribution to the topic, focusing on SAR microsatellites, was presented in the work published by BRUM et al. (DETECÇÃO E CARACTERIZAÇÃO DE ÓLEO NA SUPERFÍCIE DO MAR DO GOLFO DO MÉXICO UTILIZANDO UMA IMAGEM SAR DA CONSTELAÇÃO CAPELLA SPACE: ABORDAGEM COM DIAGRAMAS DE ESPAGOS DE ESTADOS DEFASADOS E SEMIVARIOGRAMAS (DETECTION AND CHARACTERIZATION OF OIL ON THE SEA SURFACE OF THE GULF OF MEXICO USING A SAR IMAGE OF THE CAPELLA SPACE CONSTELLATION: AN APPROACH WITH LAGGED STATES SPACES DIAGRAMS AND SEMIVARIOGRAMS). In: XX BRAZILIAN SYMPOSIUM ON REMOTE SENSING, 2023, Florianópolis. Electronic proceedings . . . São José dos Campos, INPE, 2023). The aforementioned study employs, for the analysis of these transects, an approach using the semivariogram function γ (h). However, this document does not address the analysis for oil spills nor does it refer to the generation of the vector of spatial attributes.

The shape assumed by a semivariogram γ (h) in the spherical model has a value of zero for a separation distance in pixels (h) tending to zero, rising smoothly as h increases, until a value of h is reached at which γ (h) no longer grows and settles into a horizontal line (sill), which means that the regionalized variable has reached a completely random behavior. The parameters referred to as range (a), contribution (C₁), nugget effect (C₀) and sill (C=C₀+C₁) are important characteristics of a spherical semivariogram and were considered herein as indicative of the spatial distribution of the oil spill (seepage or spill) and the surrounding sea.

The range (a) is the distance in pixels at which γ (h) reaches a sill (C) and no longer increases. The sill is usually manually adjusted to the variance of the dataset along the transect line. The nugget effect (C₀) is a discontinuity at the origin of the semivariogram, which jumps to cross the vertical axis γ (h) at a value greater than zero when h approaches zero. Each random spatial phenomenon is unique, having a semivariogram that is characteristic of the same.

Depending on the nature of the phenomenon, and especially on how it is sampled, its semivariogram may or may not exhibit the nugget effect, which indicates small-scale variability in the dataset or the presence of randomness. In this way, two distinct targets exhibit semivariograms with different geostatistical parameters, expressing unequal models of spatial correlation of the data.

Another approach used for the analysis of the transects was the obtention of the lagged states spaces diagrams, which are defined as a mathematical space, formed by orthogonal axes. The coordinates that are placed on these axes refer to the DN(x) measurements of the pixels in the SAR image. As this property changes along a given transect, these coordinates will also change, and the state point will move across the diagram, generating a point cloud. Since all the points that make up this space represent states of the system, a space of states is thus constructed.

The transect line is defined as DN(x), and, in this way, <DN(x), DN(x+k)> is constructed, where k is an integer number of pixels along the transect. Initially, in the pair <DN(x), DN(x+1)>, the points tend to concentrate along the correlation diagonal, in which DN(x) approaches DN(x+1). The other diagrams are constructed with the increment of the value of k.

To generate the vector of spatial attributes for target characterization, a first step is performed, which is represented by the construction of lagged states spaces diagrams up to the pair <DN(x), DN(x+a)>, in order to characterize the structured domain of the transect line, as defined by the spherical semivariogram. Subsequently, the diagram for the pair <DN(x), DN(x+a+1)> is elaborated, in order to investigate the behavior of the transect in the random domain.

In addition, the lagging index of each point cloud of the lagged states spaces diagrams is calculated, representing the pairs with separation distance h=1 pixel to h=a+1 pixels, relative to the correlation diagonal, in order to characterize the semivariogram transition from the structured domain (in which h<a) to the random domain (in which h>a).

Among the numerous spatial parameters or attributes extracted from oil seepages and spills from SAR images, this methodology uses those called range (a), nugget effect (C₀), sill (C), originating from the semivariogram, in addition to the lagging index (γ) in the lagged states spaces diagram (<DN(x), DN(x+k)>) with k=1 to k=a+1. In this way, the following vector of spatial attributes is defined for each target: [a; C₀; C; γ (<DN(x), DN(x+1)>); γ (<DN(x), DN(x+a−1)>); γ (<DN(x), DN(x+a)>); γ (<DN(x), DN(x+a+1)>)].

Thus, the aim is to include in the vector of spatial attributes both the structured domain and the part of the random domain of the spherical semivariogram.

A detailed analysis of the attributes that best characterize the oil seepages and spills of a specific region is fundamental in order to define a standard that represents such classes in the course of scientific investigation.

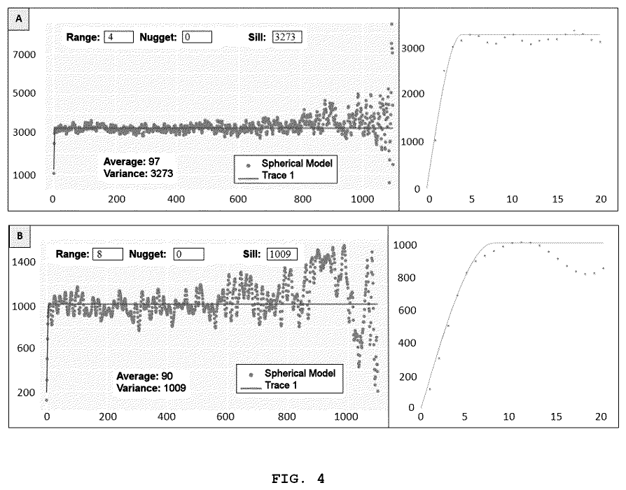

As a result, the spherical behavior was observed in the transect drawn to the sea in the original image, with a range of 4 pixels and a sill equivalent to the variance of the data, i.e., 3273, as shown in graph A of FIG. 4. As there is no indication of the presence of the nugget effect, this suggests the absence of randomness or small-scale variability in the transect. The vector of attributes obtained was [4; 0; 3273; 0.688; 0.079; 0.039; 0.000].

The data relating to the sea transect were subjected to a median filter with a 5×5 window. The spherical model can be equally applied to such filtered data as shown by graph B of FIG. 4, with a range equal to 8 pixels and a sill with a value of 1009 (variance of the digital gray levels along the transect). The nugget effect was also not verified, obtaining [8; 0; 1009; 0.885; 0.079; 0.051; 0.023] as the vector of attributes.

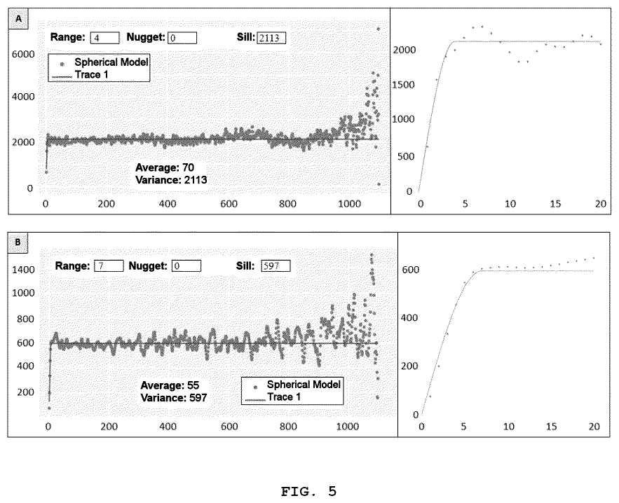

The semivariogram of the oil seepage in the original image can also be represented by a spherical model, with a value for the range of 4 pixels and a sill equivalent to the variance of the data, i.e., 2113 as shown by graph A of FIG. 5. There is no indication of the presence of the nugget effect, which also suggests in this case the inexistence of randomness or small-scale variability in the transect. The extracted vector of attributes is [4; 0; 2113; 0.700; 0.101; 0.058; 0.000].

The spherical model also fits the transect of the seepage treated with the median filter, using a 5×5 pixel window, as shown by graph B in FIG. 5. In this case, the sill corresponds to the variance of the digital gray levels in the transect. However, as in the sea transect with a 5×5 median filter, the spatial structure of the data was amplified, since the range now assumes the value of 7 pixels. The nugget effect was also not verified herein, having [7; 0; 597; 0.875; 0.008; 0.000; 0.000] as the vector of spatial attributes.

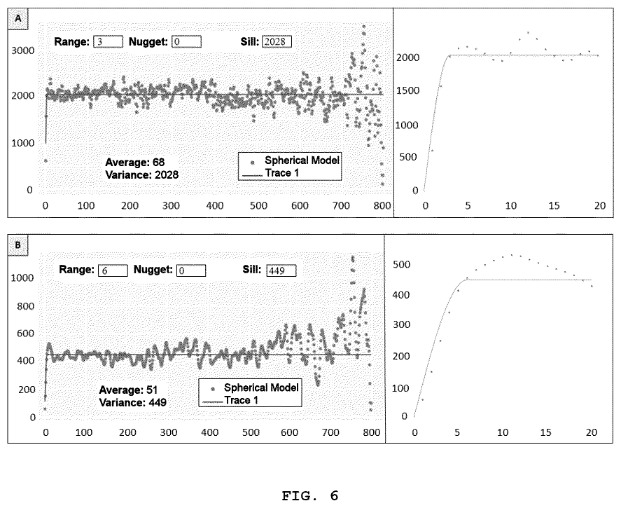

For the oil spill feature, the semivariogram in the original image can also be represented by a spherical model, with a range value of 3 pixels and a sill equivalent to the variance of the data, i.e., 2028 (FIG. 6A). The nugget effect was not observed. The resulting vector of attributes was [3; 0; 2028; 0.702; 0.230; 0.012; 0.000].

After the treatment with the 5×5 window median filter, the spherical model can equally be applied to such filtered data of the spill feature, with a range of 6 pixels and a sill with a value of 449 (variance of digital gray levels along the transect), as shown by graph B in FIG. 6. The nugget effect was also not verified, resulting in [6; 0; 449; 0.872; 0.079; 0.000; 0.000] as the vector of attributes.

It is noticeable that, for both the sea and the seepage and spill features, the median filtering resulted in a SAR dataset with increased spatial structure.

In order to analyze how the vectors of spatial attributes behave according to the SAR image to be processed, the present method was also applied to two other SAR images, from other sensors. An ICEYE image acquired on May 29, 2020, at 20:46 GMT, in the X-band, in ascending orbit, with left observation direction and VV polarization, and a Sentinel image acquired on Apr. 12, 2024, at 00:15 GMT, in the C-band, in ascending orbit, with right observation direction and VV polarization were used.

Table 1 presents the vectors of spatial attributes for the three targets studied in the CAPELLA SPACE image and also in the ICEYE and Sentinel images. Table 1: The vector of spatial attributes for the targets studied in the CAPELLA SPACE, ICEYE, and Sentinel images.

TABLE 1

| | | | Vector of spatial attributes | | | | | | |
|---|---|---|---|---|---|---|---|---|---|
| | | | | | | | γ(<DN(x), | | γ(<DN(x), |
| | | | | | | γ(<DN(x), | DN(x + a − | γ(<DN(x), | DN(x + a + |
| | | | a | C0 | C | DN(x + 1)>) | 1)>) | DN(x + a)>) | 1)>) |
| CAPELLA | Sea H1 | original | 4 | 0 | 3273 | 0.688 | 0.079 | 0.039 | 0.000 |
| SPACE | | filtered | 8 | 0 | 1009 | 0.885 | 0.079 | 0.051 | 0.023 |
| | Seepage | original | 4 | 0 | 2113 | 0.700 | 0.101 | 0.058 | 0.000 |
| | H2 | filtered | 7 | 0 | 597 | 0.875 | 0.008 | 0.000 | 0.000 |
| | Spill | original | 3 | 0 | 2028 | 0.702 | 0.230 | 0.012 | 0.000 |
| | H3 | filtered | 6 | 0 | 449 | 0.872 | 0.079 | 0.000 | 0.000 |
| ICEYE | Sea H4 | original | 0 | 667 | 667 | 0.000 | — | — | — |
| | | filtered | 3 | 0 | 343 | 0.633 | 0.226 | 0.030 | 0.044 |
| | Seepage | original | 0 | 644 | 644 | 0.041 | — | — | — |
| | H5 | filtered | 3 | 0 | 207 | 0.644 | 0.276 | 0.061 | 0.000 |
| | Spill | original | 0 | 808 | 808 | 0.032 | — | — | — |
| | H6 | filtered | 3 | 0 | 588 | 0.613 | 0.229 | 0.000 | 0.000 |
| Sentinel- | Sea H7 | original | 3 | 0 | 1646 | 0.284 | 0.074 | 0.000 | 0.000 |
| IA | | filtered | 6 | 0 | 212 | 0.735 | 0.055 | 0.018 | 0.007 |
| | Seepage | original | 0 | 27 | 27 | 0.107 | — | — | — |
| | H8 | filtered | 4 | 0 | 6.6 | 0.659 | 0.048 | 0.023 | 0.052 |
| | Spill | original | 0 | 40 | 40 | 0.225 | — | — | — |
| | H9 | filtered | 12 | 0 | 26 | 0.888 | 0.079 | 0.033 | 0.000 |

For the CAPELLA SPACE image, the <DN(x), DN(x+a−1)> diagram may be of particular interest for discriminating the oil spills as being of natural or anthropic origin, since the value of γ(<DN(x), DN(x+a−1)>) for seepage (0.008) is approximately an order of magnitude lower than that found for spillage (0.079), with the spillage approaching the sea (see column 8 of Table 1, rows 4, 6, and 8).

With respect to the sill values, the spillage approaches seepage, diverging considerably from the sea, unlike the behavior previously observed for the <DN(x), DN(x+a−1) diagram (see column 6 of table 1, rows 4, 6 and 8). Thus, it is clear that these attributes are not correlated and each has its importance for the characterization of the target.

Analyzing the vectors of spatial attributes generated for the ICEYE and Sentinel images, all targets in the original images showed a pure nugget effect, which indicates the absence of spatial structure in the data. It was further found that the filtration by median resulted in a SAR dataset with increased spatial structure in both sensors.

For the ICEYE image, the <DN(x), DN(x+a−1)> diagram behaved similarly to that observed in the CAPELLA image, with the spillage value approaching the value obtained for the sea (see column 8 of table 1, lines 10, 12 and 14). In turn, for the Sentinel image, the <DN(x), DN(x+a−1)> diagram behaved in the opposite way, with the seepage value approaching the sea, diverging from the spillage (see column 8 of table 1, lines 16, 18 and 20).

Analyzing the behavior of the sill values, it is noted that for the ICEYE image, the highest value obtained was for the spillage (see column 6 of table 1, lines 10, 12 and 14), and for the Sentinel image, the highest value achieved was for the sea (see column 6 of table 1, lines 16, 18 and 20).

In this way, the spherical behavior was observed in the semivariograms of the transect lines referring to the sea, seepage and oil spillage in the SAR images of the three sensors used in this invention. For the CAPELLA data, the nugget effect was not found in the three cases, both in the original and filtered images, which suggests the inexistence of randomness or small-scale variability. In turn, for the original ICEYE and Sentinel data, all targets showed a pure nugget effect, which indicates the absence of spatial structure in the data. It was further found that the filtration by median resulted in a SAR dataset with increased spatial structure in all three sensors.

Thus, it can be concluded that the lagged states spaces diagrams showed distinct behaviors in relation to the sea and to the seepage and spillage features, demonstrating their potential for representing such targets in the vector of spatial attributes. The <DN(x), DN(x+a−1)> diagram and the sill values may be of particular interest for discriminating oil spills as being of natural or anthropic origin.

It is important to highlight that the results vary according to the SAR image to be processed, since the sensors used operate with different configurations.

The users skilled in the art will appreciate the knowledge presented herein and may reproduce the invention in the embodiments presented and in other variants, encompassed within the scope of the attached claims.

What is claimed is:

1. A method for generating a vector of spatial attributes for characterizing oil spills on a sea surface, the method comprising:
constructing lagged states spaces diagrams up to a pair <DN(x), DN(x+a)>;
elaborating a diagram for the pair <DN(x), DN(x+a+1)>, in order to investigate a behavior of a transect in a random domain; and
calculating a lagging index of each point cloud of the lagged states spaces diagrams, representative of pairs with separation distance h=1 pixel up to h=a+1 pixels, relative to a correlation diagonal, in order to characterize a semivariogram transition from a structured domain in which h≤a) to the random domain where h>a).

2. The method according to claim 1, wherein a selection of specific spatial attributes is carried out by means of use of the semivariograms and the lagged states spaces diagrams.

3. The method according to claim 1, wherein a classification of oil spills on the sea surface as being of natural or anthropic origin is carried out based on the generated vector of spatial attributes.

4. The method according to claim 1, wherein the vector of spatial attributes of a surrounding sea is used for comparison and to aid in distinguishing an origin of the oil spills.
